(19) United States
(12) Patent Application Publication
(10) Pub. No.: US 2016/0260139 A1
(43) Pub. Date: Sep. 8, 2016

(54) Method for Forming and Managing Networked Websites with Substantially Reduced Duplicate Content

(71) Applicant: Janos Farkas, Austin, TX (US)

(72) Inventor: Janos Farkas, Austin, TX (US)

(21) Appl. No.: 15/001,227

(22) Filed: Jan. 19, 2016

Related U.S. Application Data
(60) Provisional application No. 62/104,845, filed on Jan. 18, 2015.

(51) Int. Cl. G06Q 30/02; G06F 17/30

(52) U.S. Cl. CPC G06Q 30/0277; G06F 17/30882; G06F 17/30887

(57) ABSTRACT

A method of managing content of a plurality of networked web sites includes the step of creating a plurality of websites forming a network, wherein at least one of the networked websites is an original site with original content, wherein at least one of the other of the networked websites is a promote site for the original site. The method further includes the step of generating a promote webpage containing a promoted content associated with the original content. The promote webpage is maintained on the promote site. The promote webpage includes a hyperlink for at least one element of the promoted content to the original content, wherein the hyperlink provides a reference to a location of the promote webpage and an original content URL for accessing the original content at the original site.

### CROSS-REFERENCE TO RELATED APPLICATIONS

This application claims the benefit of U.S. provisional patent application No. 62/104,845, filed Jan. 18, 2015 which is incorporated herein by reference.

### FIELD OF THE INVENTION

The present invention relates generally to web site design and more particularly to forming of plurality of web sites, connected through a network, where the content can be made visible from any of the these websites without duplicating the content being viewed.

### BACKGROUND

People seeking goods and services frequently research prospective service providers or sources of goods by performing an Internet-based search. The user enters a query into a web browser. The web browser provides the query to a search engine. The search engine processes the query and other information it may receive to return a list of websites.

The websites in the result list are ranked based upon proprietary rating algorithms. The search engine may utilize information contained within the pages referenced in the search engine results, social media ranking factors (geographically specific content visible in social media), information contained within other web pages the search engine has cataloged, information about the user provided by the querying browser (e.g., operating platform, browser, IP address), and other information when creating the result list.

Internet websites are essential elements for marketing corporations, companies, firms, franchisees, brands, networks or other organizations hereinafter collectively “businesses”. Larger businesses often have multiple locations providing similar products or services at specific geographical locations.

Websites of businesses aiming to market to clients or prospective clients nationwide often perform poorly in search engine results when the business websites are not designed appropriately for the area near the location of the business. If a search engine cannot readily determine that a particular business website is near the user's location, the business website may be excluded from or ranked very low in results generated by the search engine.

One approach for marketing geographically-specific services or businesses is through websites specific to the location. This approach works well with search engines which collect location information and generate location-sensitive search results. Users searching for service providers such as healthcare providers, plumbers, and electricians, for example, tend to be looking for service providers in an area that is geographically proximate the user.

Generally, individuals involved in local businesses are well-suited to create relevant local content. However, the infrastructure and resources required to manage web and social media can be overwhelming for small or medium size local businesses and those frequently look for less than optimal marketing alternatives with the current state-of-the-art. Most common options are: (i) list their contact information in Internet directories; (ii) become franchisees who use franchisor's template websites and content; (iii) hiring costly marketing companies. Smaller businesses may simply give up Internet marketing due to the lack of resources.

Internet directories constrain the businesses' presence to a template under the control of the owner of the Internet directory. The business generally follows a content template utilized by the directory owner. Although the content allowed may be unique, the template precludes the business from being able to adequately promote its local presence.

Franchisee websites suffer from a similar constraint. Frequently the local franchisee is limited to using a boilerplate template from the franchisor with little provision for local content. Regardless of whether any local content is present, the franchisee websites tend to have significant amounts of duplicate content from the franchisor. The duplicate content operates to lower search engine rankings.

National businesses face the issue of burdensome procedures of the prior art and lack of infrastructure for creating, integrating, and managing relevant local content. For example national businesses often make the content of their national site available to their local operation but rarely offer any options for creating and integrating relevant local content to their web or social media at local or national levels.

A commonly used “patch” for the foregoing problem is to duplicate the content of a national site to one or more local sites. However, duplicate contents result in poor user experience when visitors see substantially the same content repeated within a set of search results. Duplicate content may also result in lower search engine result rankings.

### SUMMARY

A method of managing content of a plurality of networked web sites includes the step of creating a plurality of websites forming a network, wherein at least one of the networked websites is an original site with original content, wherein at least one of the other of the networked websites is a promote site for the original site. The method further includes the step of generating a promote webpage containing a promoted content associated with the original content. The promote webpage is maintained on the promote site. The promote webpage includes a hyperlink for at least one element of the promoted content to the original content, wherein the hyperlink provides a reference to a location of the promote webpage and an original content URL for accessing the original content at the original site.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings in which like references indicate similar elements and in which:

FIG. 1 illustrates one embodiment of a computing device that may be used to access the plurality of networked websites or perform various steps in the methods described with respect to FIGS. 2-10.

FIG. 2 illustrates one embodiment of a plurality of networked web sites.

FIG. 3 illustrates a high level of one embodiment of a process that is used to form a plurality of networked web sites with reduced duplicated content.

FIG. 4 illustrates one embodiment of essential sections of a web page.

FIG. 5 illustrates a webpage comprising promoted contents of a promote site.

FIG. 6 illustrates a webpage rendered by the method of FIG. 3.

FIGS. 7-10 illustrate various configurations of control, sub-control, central and sub-central sites for managing content on the networked websites.

For simplicity and clarity of illustration, elements illustrated in the drawings have not necessarily been drawn to scale. For example, the dimensions of some of the elements are exaggerated relative to other elements for clarity. Further, where considered appropriate, reference numerals have been repeated among the drawings to indicate corresponding or analogous elements.

### DETAILED DESCRIPTION

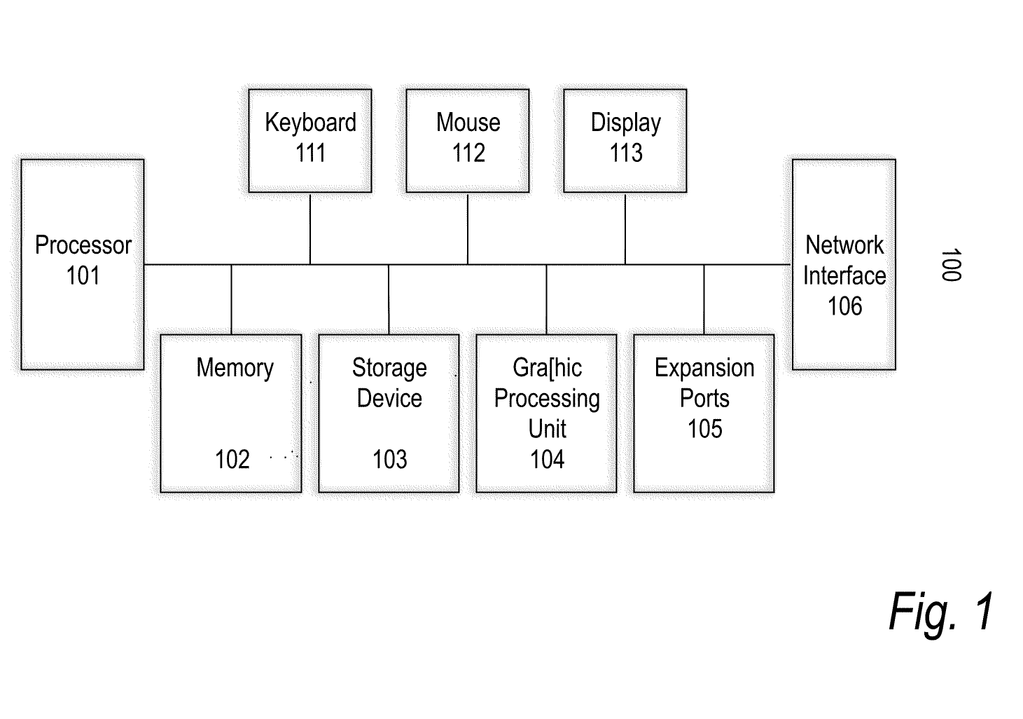

Generally, FIGS. 1-10 disclose methods and apparatus for managing content on networked websites without (or with significantly reduced) duplicate content.

The method is inspired by solving the problem of the prior art related to websites of businesses with multiple geographic locations. However FIGS. 1-10 herein teach a method which has a broader application and provides an improved process in general for forming and managing the content of networked web sites without (or with reduced) duplicate content.

The detailed description will use the terms: “networked sites” for a plurality of websites hosted on a single or plurality of computing devices, which are communicating over public internet, private internet or other network to access the content of said sites. The term “original content” refers to content created on any website of the network. Ignoring redundancies that may be created for load leveling or fault tolerance, only one web site of the network maintains the original content in full including title, text, images, videos, hyperlinks, etc. “Origin site” or “original content site” refers to a website of the network containing the original content.

“Promoted content” refers to a summary of the original content typically containing one or more of a title, featured image and excerpt. “Promote site” refers to any website of the network containing promoted content. “Promote” refers to the process of placing promoted content on any of the promote sites.

These terms are used in reference to a specific content, therefore the same site can be both origin and promote site depending on the content referenced. Furthermore the term “network” is used for origin site and promote site collectively.

“Central site” is used for the website of the network which contains the promoted content from all other websites of the network. “Control site” refers to a website of the network which contains the promoted content from all other websites of the network and distributes those to selected promote sites. “Cluster site” is used for the website of the network which contains the promoted content from at least two websites of the network; “External site” refers to a website that is not one of the networked websites. “Syndicate” or “syndication” refers to placing promoted content on an external site.

“URI” or Uniform Resource Identifier is a string of characters that identify a resource on a network. “URL” or Uniform Resource Locator is a type of URI that identifies a location and for a resource located on a network. The term “website” may be used to refer to a URL, one or more files accessible via the URL, a domain identified by the URL, or the computing device associated with the domain identified by the URL as the context dictates. A “browser” is an application that renders the resource identified by the URL. A browser for example may read a file identified (implicitly or explicitly) by the URL and display (render) contents of that file and other files in accordance with presentation instructions in that file.

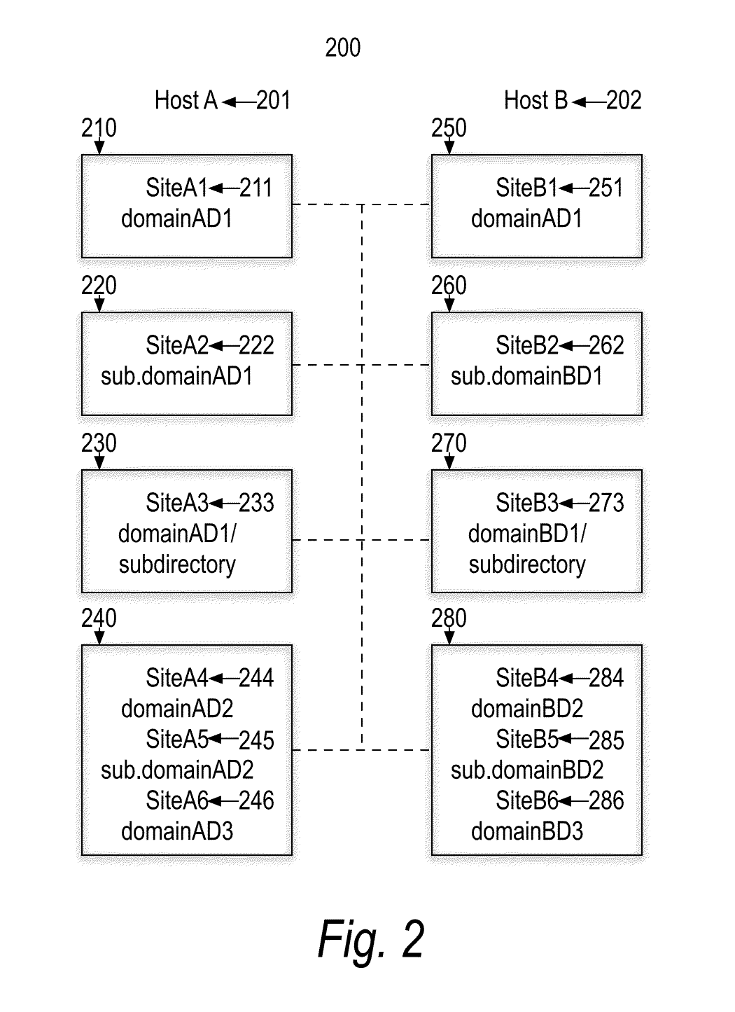

FIG. 1 illustrates one embodiment of a computing device 100 that may be used to implement the system and method of FIGS. 2-10. Computing device 100 includes a processor 101, memory 102, storage device 103, graphic processing unit 104, expansion ports 105, network interface 106. The computing device can also include keyboard 111, pointing device such as mouse 112 and display 113. Each of the components 101, 102, 103, 104, 105, 106, 111, 112 and 113 are interconnected using various buses and may be mounted on common motherboard or multiple circuit boards as appropriate. Some of the devices e.g. 111, 112, 113 can be also connected to wireless interface.

The processor 101 can process instruction, including instructions stored in the memory 102 or on the storage device 103 to display through the graphic processing unit 104. Multiple processors and/or multiple memories, storage devices and graphical processing units may be used as appropriate. Also, multiple computing devices connected with each other may be used with each device providing portions of the operations.

The memory 102 can be volatile or non-volatile memory, which stores the information, stores the information. Typical implementations of memories are static random access memory, dynamic random access memory and in some cases flash memory.

The storage device 103 is providing mass storage of information in the computing devices. Most common implementations are using flash or had disk devices. In some other implementation optical storage such as CD or DVD are used.

The network interface 105 provides a convenient communication between computing devices 100.

The computing device may be implemented as a standard server or a group of servers. In addition the computing device may be implemented in a personal computer or in a mobile device. The entire system may be made up of a multiple computing devices communicating with each other in the same or in different physical location as necessary, which are not shown in FIG. 1, but further detailed in FIG. 2.

FIG. 2 illustrates one embodiment of a plurality of networked websites 200. The websites of the network can be associated with the same domain name, for example 211, 222, 233 or 251, 262, 273 including the subdomains 222 or 262 thereof 211 and 251 respectively. Furthermore, the websites of the network can be also associated with the subdirectory 243, 273 of the domains 211, 251 respectively. Also in other embodiment the websites of the network can be associated with two or more domain names 211, 244, 246, 251, 284, 286 and the subdomains 222, 262 thereof.

The networked sites can be hosted on the same 240 or 280 or on plurality servers e.g. 210, 220, 230, 250, 260, 270. The servers can be hosted on the same or multiple host 201, 202 if is necessary for the system.

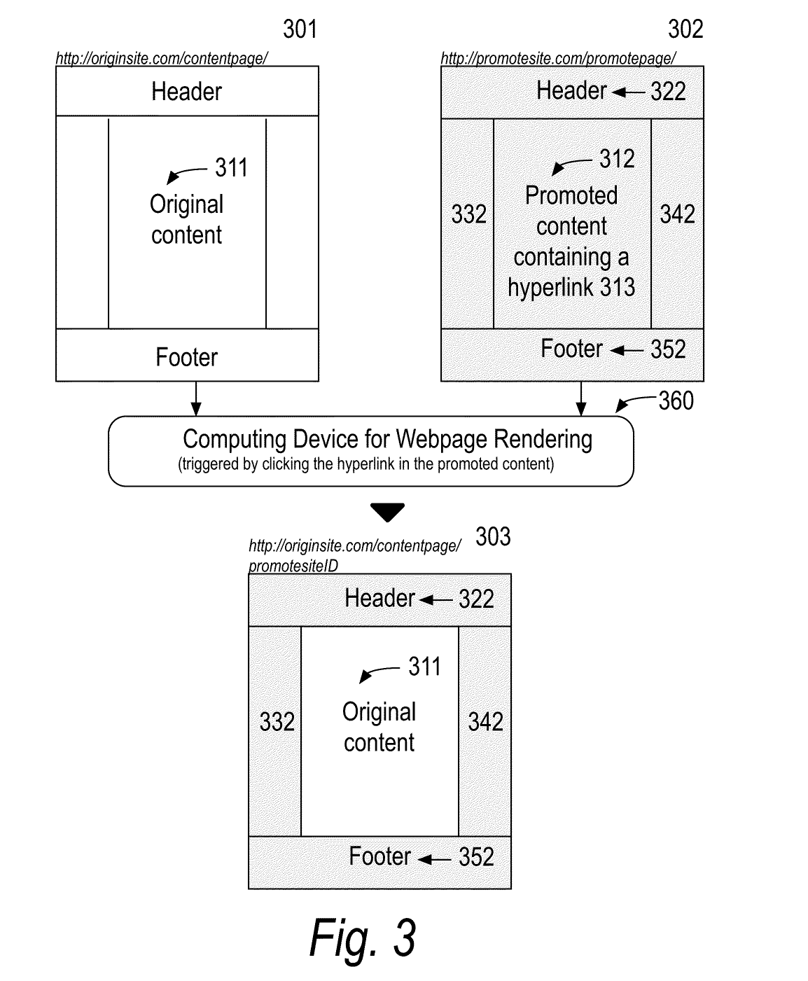

FIG. 3 shows at high level the improved method which promotes an original content 311 from an origin site 301 using its promoted content 312 to a promote site 302 containing a hyperlink 313 to the original content 311 with a reference to the promote site 302. Clinking on the hyperlink 313 triggers a rendering algorithm on the computing device 360 for a webpage 303 comprising the original content 311 in its body with the rest of the page such as header 322, left sidebar 332, right sidebar 342, and footer 352 compiled from the promote site 302. The method thought herein improves the visitor experience, increases the visibility of the websites, and simplify the management of the content without the duplication thereof.

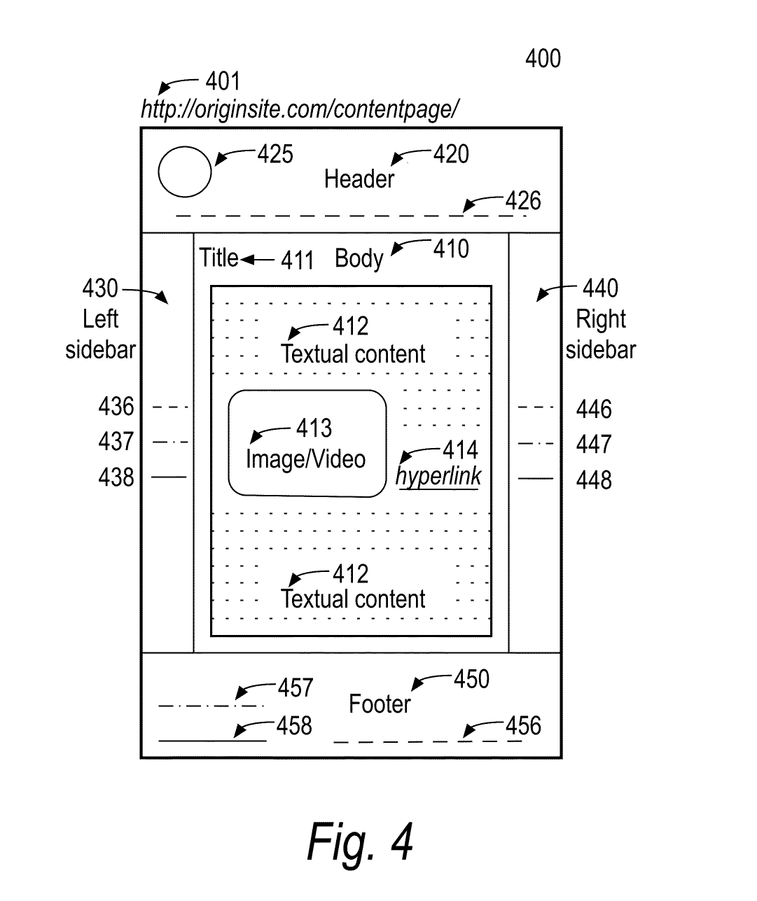

Specific process details can be better understood with specific references to FIGS. 4-10 herein below.

FIG. 4 shows the sections of a webpage 400 prevalent to the invention, wherein the original content is displayed in the body 410 of the page at a URL of http://originsite.com/contentpage 401. The typical components of the original content are: the title 411, text 412, images or videos 413, and hyperlinks 414. The header 420 frequently includes a logo 425 and various menus 426. The left sidebar 430 frequently contains menus 436 and links to internal 437 or external webpages 438. The right sidebar 440 and the left sidebar 430 often have menus 446 and links to internal 447 or external webpages 448. The footer 450 also most commonly has menus 456 and links to internal 457 or external webpages 458. In addition the webpages often contain advertisements, search bars, which can be placed in any sections of the page. Moreover, featured images and taxonomies including categories and/or tags can be assigned to the original content and can be displayed or can be hidden to visitors on the webpage displaying the original content. The taxonomies can be utilized to filter the original content for which the promoted content will be placed on any of the promote sites.

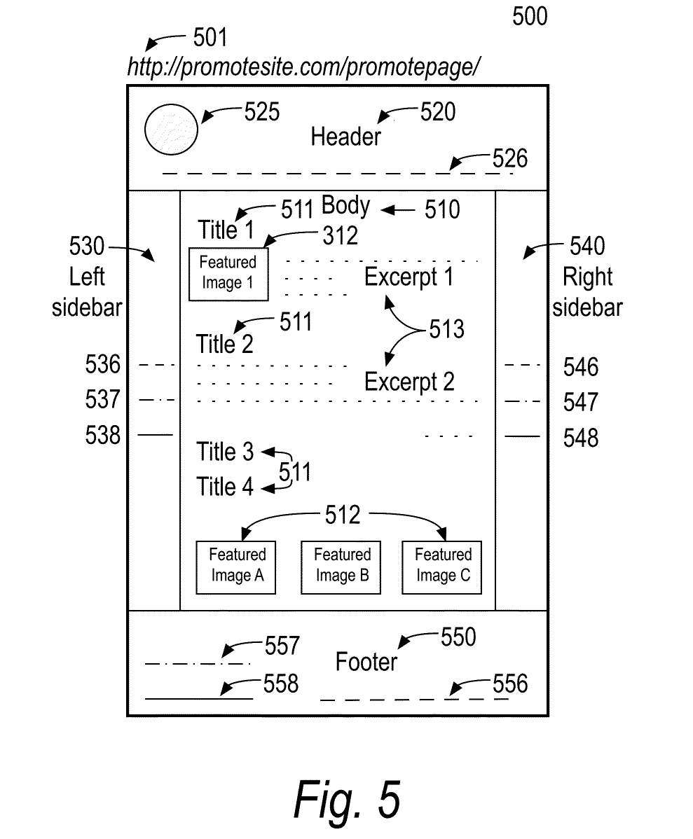

FIG. 5 shows a webpage 500 comprising promoted contents of a promote site at a URL of http://promotesite.com/promotepage 501, wherein the promoted content is displayed in the body 510 of the page. The promote page has similar other sections as can be found on the origin site, the header 520 comprises usually a logo 525 and various menus 526. The left sidebar 530 frequently comprises menus 536 and links to internal 537 or external webpages 538. The right sidebar 540, similarly the left sidebar 530 usually comprises menus 546 and links to internal 547 or external webpages 548. The footer 550 also most commonly comprises menus 556 and links to internal 557 or external webpages 558. The elements of the promoted content, titles 511, featured images 512, excerpts 513 or combination of thereof. When the promoted contents contains only titles and/or featured images those can also be conveniently displayed in the left, right sidebars or in the footer of the promote sites. The elements of the promoted content are directly hyperlinked from the title 511 and/or featured image 512 to the webpage containing the original content. Alternatively, a hyperlinked text is added to the part of the excerpt 513 e.g. “read more”, “learn more”, “continue reading”, “continue” or alike on the promote site. Often the webpage also contains advertisements, search bars, which can be in any section of the page. Moreover, taxonomies including categories and/or tags can be assigned to the promoted content, which can be displayed or can be hidden to visitors on the page displaying the promoted content. The taxonomies can be utilized to organize the promoted content on the promoted sites. The webpages of the promote site containing the promoted content can maintain the existing styling of the promote site or can be specifically created for webpages containing the promoted content.

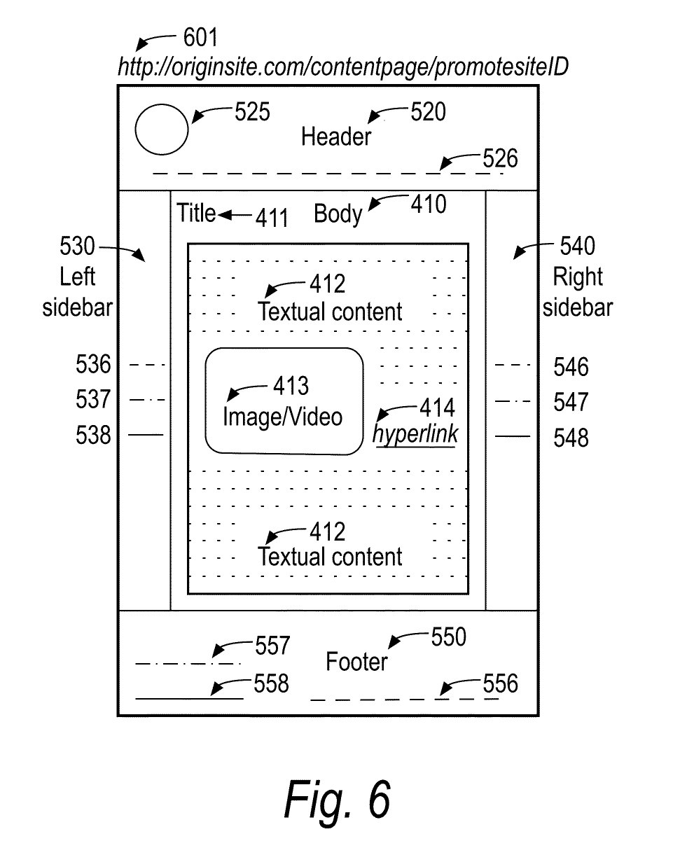

Clicking the hyperlink in the promoted content directs the web browser to the original content 410 on the origin site, as illustrated in FIG. 6. A webpage is rendered with the original content 411, 412, 413, 414, in its body 410 whereas maintaining the header 520, 525, 526; right 530, 536, 537, 538; left 540, 546, 547, 548 sidebars and footer 550, 556, 557, 558 including the styling of the promote site. This process gives a seamless engagement of the visitor entering the origin site from the promote site. In the meantime the direction of the web browser by the hyperlink to the original content eliminates the duplication of the original content. This task can be achieved by either including a postfix into the hyperlink e.g. originsite.com/contentpage/?promotesiteID 601 specific to the promote site or by applying appropriate session cookies from the visitors. Either or both of those can control the rendering algorithm for the webpage providing results, as described above. When a postfix to the hyperlink is applied the promoted content will also be assigned to a canonical URL pointing to the original content http://originsite.com/contentpage 401. Alternatively the promoted content can be assigned with a no-index tag.

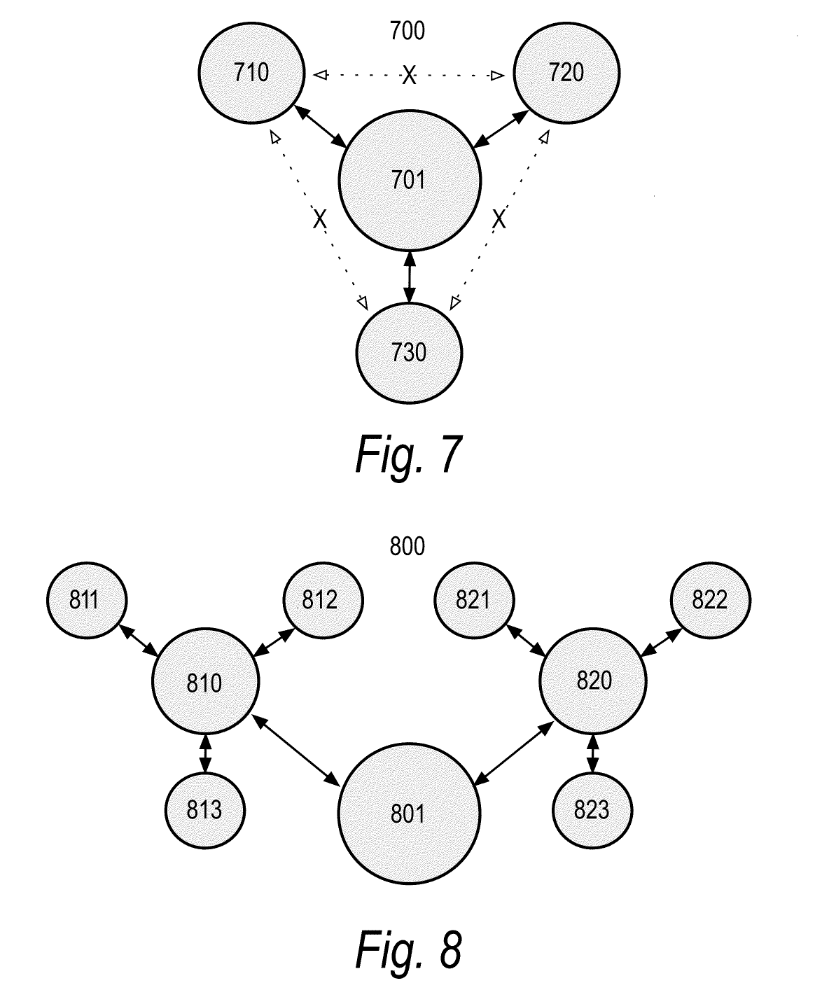

FIG. 7 illustrates the second embodiment of the invention wherein one site of the networked sites 700 is a control site 701. The promotion of the original content can be initiated between the control site and any of the promoted sites as detailed in the first embodiment, but cannot be initiated between two non-control sites 710, 720, 730. The control site 701 contains the promoted content from all other websites of the network and distributes those to selected promote sites, specific to the original content. This embodiment can be advantageous when it is desired to control the distribution of the promoted content through a dedicated website 701 of the network 700.

FIG. 8 illustrates the third embodiment of the invention wherein one site of the network 800 is a control site 801 and there are two 810, 820 or more sub-control sites which control the promoted content for the rest of the websites 811, 812, 813, 821, 822, 823 assigned to these sub-control sites 810, 820 in the network. Meanwhile, the control site is controlling the promoted content of the sub-control sites. The remaining steps of the process of this embodiment are essentially the same as detailed in the first and second embodiments. This embodiment can be advantageous when it is desired to control the distribution of the promoted content through departmentalized websites 810, 820, which are controlled by a dedicated website 801.

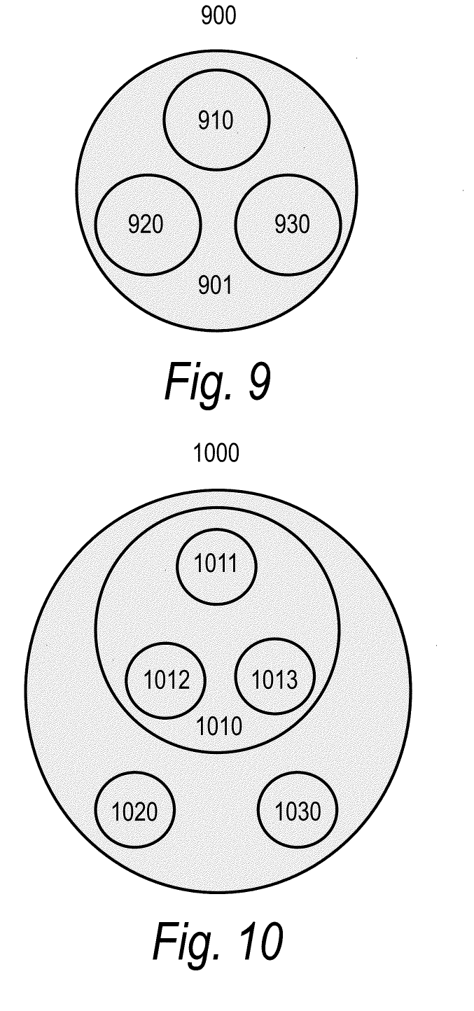

FIG. 9 illustrates the fourth embodiment of the invention wherein one site 901 of the network 900 is a central site, which contains the promoted content from all other websites 910, 920, 930 of the network The promotion between the origin and promote sites can be carried out as detailed in the first and second embodiments. This embodiment can be advantageous when it is desired to distinguish one site containing all promoted content of the network.

FIG. 10 illustrates the fifth embodiment of the invention wherein at least one site of the network 1000 is a cluster site 1010. The cluster site contains the promotion content from the website 1011, 1012, 1013 associated with the cluster. The network can have a center site 1001 in addition of the cluster site 1010. The promotion between the origin and promote sites can carried out as detailed in the first, second and third embodiments. This embodiment can be advantageous when it is desired to create a multiplicity of clustered networked sites. Clusters for example can be associated with geographic areas based on counties, metros, states or countries etc.

In any of the embodiments described in the foregoing the websites can associated with the same or different domains and/or the subdomains and/or subdirectories thereof. Furthermore, the website can be hosted on the same or on different servers, additionally the servers can be residing on the same or on the different host.

Furthermore the method detailed in this invention can be combined with syndication of the selected promoted content to the pages of external sites, such as social media sites e.g. Facebook, Google+, Twitter, Pinterest, Instagram, LinkedIn etc. Methods of syndication are known in the prior art. One benefit of combining prior art syndication with the method described in this invention is the simplification of the user interface.

Although the invention has been described and illustrated with reference to the specific embodiments, it is not intended that the invention be limited to the illustrative embodiments. Those skilled in the art will recognize that modifications and variations may be made without departing from the spirit and scope of the invention. Therefore, it is intended that this invention encompass all of the variations and modification as fall within the scope of the appended claims.

What is claimed is:

1. A method of managing content of a plurality of networked web sites comprises:
creating a plurality of websites forming a network, wherein at least one of the networked websites is an original site with original content, wherein at least one of the other of the networked websites is a promote site for the original site; and
generating a promote webpage containing a promoted content associated with the original content, wherein the promote webpage is maintained on the promote site, wherein the promote webpage includes a hyperlink for at least one element of the promoted content to the original content, wherein the hyperlink provides a reference to a location of the promote webpage and an original content URL for accessing the original content at the original site.

2. The method of claim 1 wherein the promoted content contains at least one of a title, an excerpt, and an image from the original content.

3. The method of claim 2 wherein the at least one element hyperlinked is the title.

4. The method of claim 2 wherein the at least one element hyperlinked is the excerpt.

5. The method of claim 2 wherein the at least one element hyperlinked is the image.

6. The method of claim 1 wherein the reference to the location of the promote webpage is a promote webpage URL.

7. The method of claim 1 wherein the reference to the location of the promote webpage is provided as a postfix to the original content URL.

8. The method of claim 1 wherein the reference to the location of the promote webpage is provided as a session cookie.

9. The method of claim 1 wherein the promote webpage assigns a no-index tag to the promoted content.

10. The method of claim 1 wherein the promote webpage assigns a canonical URL to the promoted content.

11. The method of claim 1 wherein the networked websites have a same domain name.

12. The method of claim 1 wherein at least one of the networked websites has a domain name distinct from a domain name of another of the networked websites.

13. The method of claim 1 wherein the networked websites are hosted on a same server.

14. The method of claim 1 wherein hosting of the networked websites is distributed among at least two servers.
